(19) United States
(12) Patent Application Publication
(10) Pub. No.: US 2004/0017918 A1
(43) Pub. Date: Jan. 29, 2004

(54) Process for point-to-point secured transmission of data and electronic module for implementing the process

(76) Inventor: Christophe Nicolas, Preverenges (CH)

Correspondence Address: Supervisor, Patent Prosecution Services, PIPER RUDNICK LLP, 1200 Nineteenth Street, N.W., Washington, DC, 20036-2412, US

(21) Appl. No.: 10/289,374

(22) Filed: Nov. 7, 2002

(30) Foreign Application Priority Data
Jul. 24, 2002 (CH) CH 1298/02

(51) Int. Cl. H04L 9/00

(52) U.S. Cl. 380/279

(57) ABSTRACT

A communication system for point-to-point communications of content such as video files in a video on demand system employs one or more keys specific to a user. Upon receiving a request including a specific user ID for a content, the transmission end uses the specific key corresponding to the user to encrypt control words that are transmitted to the user, to encrypt control words before they are used to encrypt the content at the transmission end, to encrypt the content itself, or some combination of the foregoing. A user unit performs the reverse operation using one or more specific keys stored in the user unit and/or a security module associated with the user unit. The user unit also uses a specific key to encrypt any content that is stored at the user unit.

### TECHNICAL FIELD

This invention concerns a process for point-to-point secured transmission of data between a managing centre and one unit among a plurality of user units linked to said managing centre.

It also concerns an electronic module allowing the implementation of this process.

### PRIOR ART

In the general case of the point-to-point data diffusion, and in particular in the case of the diffusion of videos on demand (VOD), data files, containing for example images and sound, are stored in a database, denominated “managing centre” or “VOD server”. Those data or files are especially all those that can be ordered by all the users linked to this managing centre. The data are also files that can be diffused, in particular all the data that can be diffused on channels accessible by subscription. In the following text, the data to be transmitted are denominated the content.

Intermediate centres can be placed between the managing centre and the user units. These intermediate centres carry out part of the operations related to the data transmission and the verification of the rights and are used in some exits as relay transmitters. In the following text, the terms “managing centre” or “VOD server” also include these intermediate centres. Such centres are especially described in publication WO 00/11871.

The content of the data files can be stored, as is well known by the man skilled in the art, in clear or, more currently, in a pre-encrypted way. These files contain video data on one hand, that is to say generally, images and sound, and service information on the other hand. This service information is data that allows one to manage the use of the video data, and especially includes a header. This information can be in clear or partially encrypted.

When a user wishes to obtain the content of a file, for example to display a video file, an order is transmitted at the managing centre which sends, to a receiver/decoder of the user, on one hand the video file in the form of a stream of encrypted data and, on the other hand, a stream of control messages allowing the decryption of the data stream. This second stream is called ECM stream (Entitlement Control Message) and contains “control words” (cw), regularly renewed, and used to decrypt the encrypted content sent by the managing centre. In the ECM stream, the control words are generally encrypted by a key specific to the transmission system between the managing centre and a security module associated to the receiver/decoder. In fact, the security operations are carried out in a security module that is generally realized in the form of a microprocessor card, reputed to be inviolable. This unit can be either of a removable type, or be directly integrated in the receiver.

At the time of encrypting a control message (ECM), it is verified, in the security module, that the right to accede to the considered content is present. This right can be managed by authorisation messages (EMM=Entitlement Management Message) that load such a right into the security module. Other possibilities are also conceivable, such as the sending of particular decryption keys especially.

The conditional access digital data diffusion is schematically divided into three modules. The first module is in charge of the encryption of the digital data by control words cw and the diffusion of those data.

The second module prepares the control messages ECM containing the control words cw, as well as the access conditions and diffuses them to the users intention.

As for the third module it prepares and transmits the authorisation messages EMM, which assume the definition of the reception rights in the security modules connected to the receivers.

While the two first modules are generally independent from the recipients, the third module manages the totality of the users and diffuses information for one user, for a group of users or all the users.

As mentioned above, at present, in most concrete executions, the control words change at regular intervals and are the same for all users. A user can thus obtain the control words “conventionally”, by subscribing to a corresponding service or by paying the rights related to the diffusion of the ordered information. These control words can then be diffused to other users not having the necessary rights. In the case where falsified security modules circulate, in which the verification of the rights is not carried out or the response to this verification always gives a positive result, such a security module would thus return the control words in clear to the decoder. In this case, it is possible that other people use the control words obtained in this way, without having the benefit of the corresponding rights, since these control words are identical for all users. This is especially important because the point-to-point diffusion is rarely actually point-to-point between the managing centre and each receiver/decoder linked to this managing centre. Very frequently, this diffusion is done in a point-to-point way from the managing centre to a “communication node” serving for example a building or a residence quarter. Starting from this communication node, all the receivers/decoders are linked to one another by an “internal” network. It is thus possible, in certain conditions, to give to all the members of this internal network, the benefit of the rights of one of the members.

The electronic modules used at present in the receivers/decoders essentially include a calculation unit, memory, a descrambler and a sound and images decompressor. These modules are capable of decrypting data that have been encrypted only once. The exit of such a module is an analogical signal that can be used for displaying the data file. In addition to this module, a receiver/decoder includes a reception part by cable, satellite or earth in charge of selecting and receiving the signal as well as shaping it.

The working of such a module is defined by a norm connected to the standard DVB (Digital Video Broadcasting) or other owners' norms (such as DirectTV), and the operations that it is susceptible to carry out are fixed. This module is not capable of carrying out certain operations, which can prove to be indispensable according to the data transmission processes used.

### OBJECTS OF THE INVENTION

This invention proposes avoiding the drawbacks of the processes of the prior art by carrying out a process for the encrypted data transmission, in which the data decrypted by one of the users are not usable by another.

This object is achieved by a process for point-to-point secured transmission of data between a managing centre and a unit among a plurality of user units linked to said managing centre, said data including a content encrypted by at least one control word, each user unit including at least one decoder/receiver provided with at least one encryption key specific to each user unit, characterized in that it includes the following steps:

transmitting a request from the user unit to the managing centre requesting the sending of a specific content,

transmitting a unique identifier to the managing centre, this identifier allowing to unequivocally determine the user unit having transmitted the request,

determining, from a database associated with the managing centre, the key corresponding to said user unit having transmitted the request,

determining the control word or words associated with the content to be transmitted,

encrypting these control words with said key corresponding to said user unit having transmitted the request, to obtain encrypted control words,

transmitting the encrypted control words to the user unit having transmitted the request, and

transmitting said encrypted content to the user unit having transmitted the request.

This object is also achieved by a process for point-to-point secured transmission of data between a managing centre and a unit among a plurality of user units linked to said managing centre, said data including a content encrypted by at least one control word, each user unit including at least one decoder/receiver provided with at least one encryption key specific to each user unit, characterized in that it includes the steps consisting of:

transmitting a request from the user unit (to the managing centre requesting the sending of a specific content,

transmitting a unique identifier to the managing centre, this identifier allowing to unequivocally determine, the user unit having transmitted the request,

determining, from a database associated with the managing centre, the key corresponding to said user unit having transmitted the request,

determining the control word or words associated with the content to be transmitted,

encrypting the data to be transmitted, in a specific way for each user unit,

transmitting these encrypted content to said user unit having transmitted the request,

transmitting the encrypted control words to the user unit having transmitted the request.

This invention proposes furthermore avoiding the drawbacks of electronic modules of the prior art by making a module which is capable of decrypting data streams specific to a user unit.

This object is achieved by an electronic module including a calculation unit, memory, a descrambler, a sound and images decompressor and a decrypting stage working with a key specific to each user unit.

### BRIEF DESCRIPTION OF THE DRAWINGS

This invention and its advantages will be better understood with reference to different embodiments of the invention in which:

FIG. 1 is an overall view of the device for implementing the process according to the invention;

FIG. 2 represents a first embodiment of the process of the invention;

FIG. 3 shows a second embodiment of the process of the invention;

FIG. 4 represents a variant of the process of FIG. 3;

FIG. 5 represents a combination of the embodiments of FIGS. 2 and 3;

FIG. 6 represents a combination of the embodiments of FIGS. 2 and 4;

FIG. 7 shows a particular embodiment of the process according to the invention;

FIG. 8 represents an electronic module according to this invention;

FIG. 9 shows in detail, a first embodiment of a part of the process according to the invention; and

FIG. 10 is similar to FIG. 9 and shows a second embodiment of a part of the process according to the invention.

### MODES FOR CARRYING OUT THE INVENTION

The description of the invention is made while supposing that the point-to-point communication is established between a digital files server used in video on demand and a unit placed at a user's home, denominated user unit. The digital file can be a video file and generally contains images and sound and can contain other information, especially service information allowing the treatment of data.

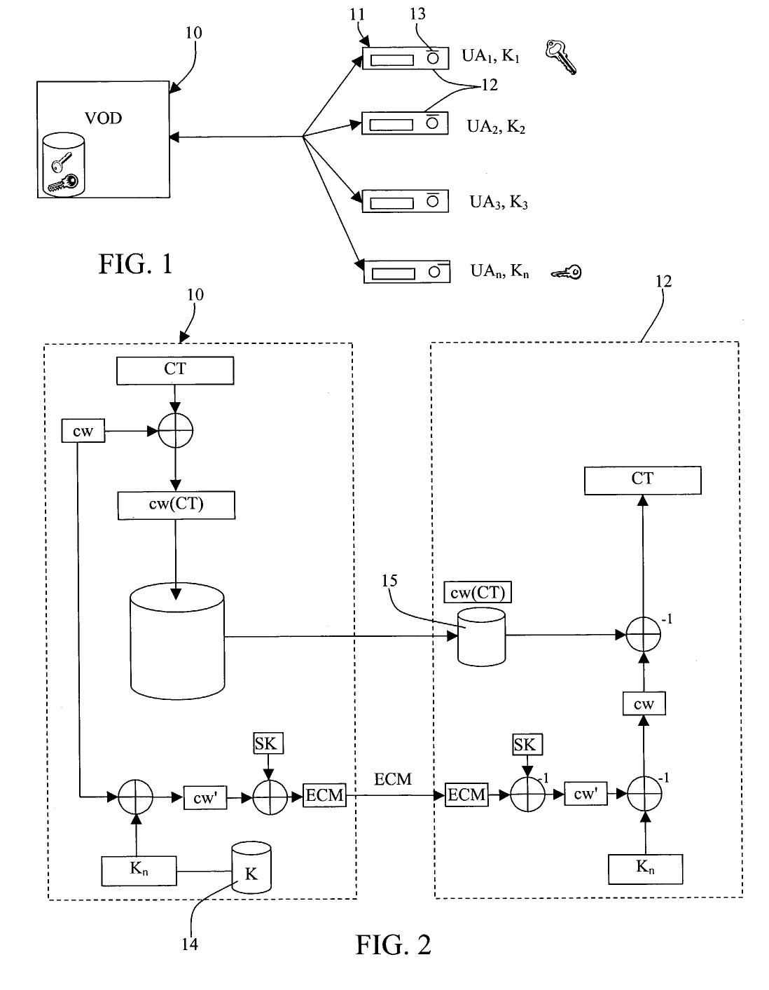

FIG. 1 represents a video server or a managing centre for video on demand, in which files, relating to products such as for example films or sports events are stored, these files being able to be ordered by users. It also shows several user units 11, each one formed by a receiver/decoder 12, possibly associated with a security module 13, each unit being placed at a user's home. As is illustrated schematically by FIG. 1, each user unit has a unique identification number (UA₁, UA₂, . . . UAₙ), and a key (K₁, K₂, . . . . Kₙ) also unique and different for each unit. This key can be a so-called symmetrical key or one of the keys of an asymmetrical key pair. In the following text, the word key is indifferently used for both possibilities, except if it is explicitly specified which kind of key is talked about. The security module 13 can be made for example in the form of a removable microprocessor card in the receiver/decoder or integrated inside it. It can however also be lacking such a security module. When a security module is foreseen, it preferably includes a key, which allows one to make a pairing between the security module and the receiver/decoder 12. The key (K₁, K₂ . . . Kₙ) placed in the user unit can be, according to the case, introduced in the receiver or in the security module. It is also possible to provide a key in each element. When the localization of the key is not specified, it either means that it is obvious for the man skilled in the art, or that the localization is indifferent.

By analogy, the unique identification number can be connected to the receiver, to the security module or to both. The unique constraint which is imposed, is that of being able to identify a user unit from those that are connected to the managing centre without ambiguity.

FIG. 2 shows an embodiment of the method according to the invention, in which the video server 10 sends a digital file to one of the user units 12 represented in FIG. 1.

The method as described with reference to FIGS. 1 and 2 operates in the following way:

When a user, possessor of a unit n, having a unique identification number UAₙ wishes to display the content of a digital file, he sends a request to the managing centre 10 or to the VOD server. This request contains in particular the unique identification number UAₙ, which allows the VOD server to identify the unit that has sent the request.

The VOD server contains a database 14 having, especially the identification numbers (UA₁, UA₂, . . . UAₙ) as data, these numbers being unique to each unit connected to the server, as well as a key (K₁, K₂, . . . Kₙ) connected to this unit. This key can be a symmetrical key, which is thus identical in the unit and in the database of the VOD server. It can also be a so called asymmetrical public key originating from a pair of asymmetrical keys. The other key of the pair, namely the key known as private, is stored in the user unit. This key can be stored permanently in an electronic module or microprocessor of the decoder/receiver for example. The symmetrical key or the pair of asymmetrical keys is unique and different for each receiver.

Mode with Personalized Control Words

Conventionally, the content (CT) of the digital file is encrypted, either before storage in the VOD server, or on the fly, at the moment of its diffusion, by means of control words cw. The encrypted file is sent to the receiver in which it can be memorized in a mass storage 15 or it can be decrypted in such a way as to be made visible by the user.

To decrypt the content, it is necessary to have the control words cw. These are first encrypted by means of the key Kₙ contained in the database and specific to a user unit. This key is either the symmetrical key, or the public key of the pair of asymmetrical keys. One thus obtains encrypted control words cw′=Kₙ (cw) which are specific to each user unit. These encrypted control words are transmitted conventionally, for example by encrypting them with a encryption key known as system key SK which is identical for all the user units connected to the managing centre. This encryption with the system key allows one to obtain the control messages file, which is sent in the form of ECM stream, to the user unit n having requested the video file. As the control words have been encrypted by means of a encryption key Kₙ that is unique and different for each user unit, they are also unique and different for each unit.

The user unit n concerned by this stream has either the symmetrical key, or the private asymmetrical key relating to the public key used for the encrypting of the control words. This allows it to decrypt the control words cw′ by applying the key Kₙ to these control words cw′ and obtaining them in clear.

The video stream encrypted and memorized in the receiver can then be decrypted using the control words in clear. It should be noted that memorization of the video stream can be carried out in advance and that any delay can occur between memorising and displaying the product. It is also possible to use the information of the video file and the control words without memorization of the video stream, by decrypting on the fly.

As the control words cw are encrypted with a key Kₙ specific to a given receiver, the fact of obtaining the information appearing in the ECM stream does not give access to usable information for a group of users. A falsified card in which all the rights available are mentioned as being acquired would thus not allow to display data coming from another user. The specific key can be contained in the security module or in the receiver.

In this embodiment, the data can be stored in clear or encrypted in the managing centre 10, this second solution often being preferred in practice. This does not change anything regarding the process. The only constraint is to have sufficient calculation power if the data are encrypted on the fly.

Mode with Content Personalized by the Control Words

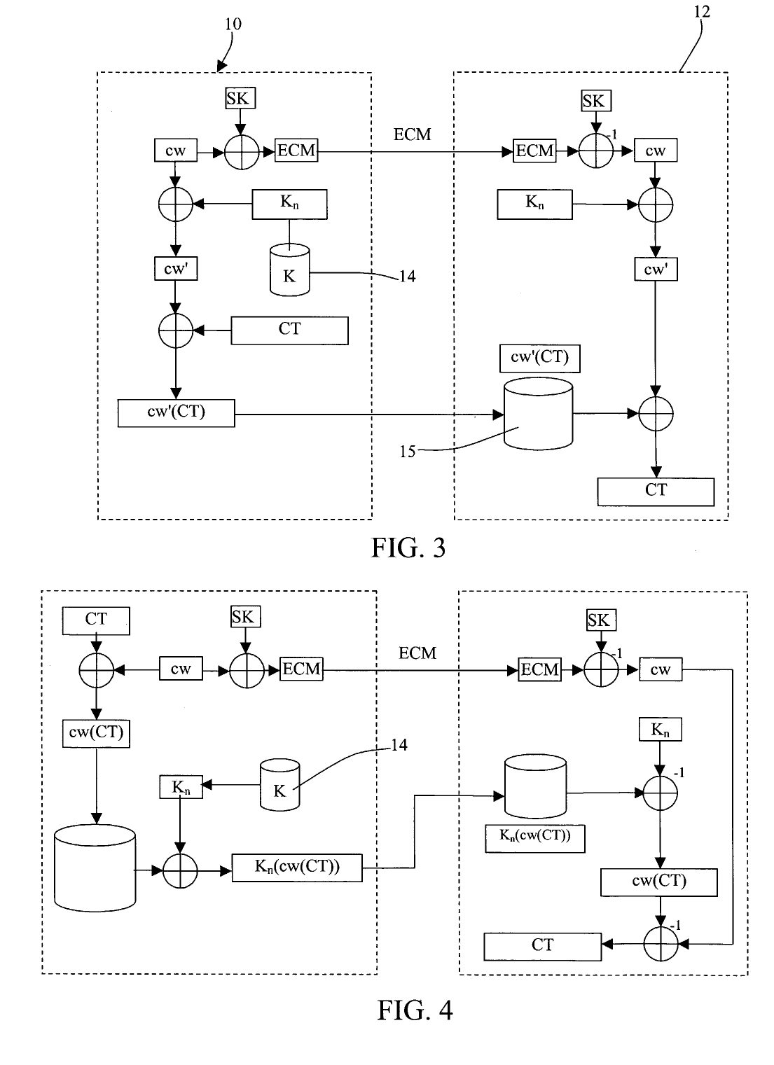

The second embodiment, disclosed by FIG. 3, is particularly well adapted to the case where the receivers 13 have the capacity to memorise files, allowing them to memorize at least one complete video file. In this embodiment, the control words cw are first encrypted with the key Kₙ of the user unit n. This key, which must be a symmetrical key, is contained in the database 14 of the VOD server. The encrypted control words cw′=Kₙ (cw) are obtained in this way. The content of the video file is then encrypted with the encrypted control-words cw′. This content may be memorized in the managing centre 10, although it is not a preferred solution. More generally, it is sent directly to the receiver n where it is intended to be registered in the mass storage 15 or displayed directly.

Given that the key Kₙ that allows one to encrypt the control words cw is different for each user unit, the encrypted content will also be different for each receiver. It is thus advisable to store the encrypted content in the memory of the receiver, rather than to memorize the content in the VOD server, which will only be able to operate for one receiver.

At the same time, the control words cw are encrypted conventionally, for example with a system key SK, in such a way to create an ECM file which is sent in the form of a stream to the related receiver.

When the receiver must decrypt the content that it has memorized, it must first conventionally decrypt, the control words cw that has been sent in the ECM stream. To do this, it uses the opposite operation to encrypting by means of the system key SK.

The decryption of said content is carried out in the following way: the control words cw are decrypted as mentioned above. They are then encrypted by means of the symmetrical key Kₙ that has been used in the VOD server to encrypt the control words. The encrypted control words cw′=Kₙ(cw) are obtained in this way. By applying these encrypted control words cw′ to the encrypted content, one obtains the content CT in clear.

In this embodiment, it is important than the key Kₙ is symmetrical. In fact, the video file CT is encrypted with already encrypted control words. It is necessary that the encrypted control words in the managing centre and those encrypted in the user unit are the same, otherwise, the decrypting of the data file is not possible.

As in the previous embodiment, the data transmitted from the VOD server 10 to the user units 12 are different for each unit. So, persons not having acquired the rights related to the transmitted content cannot use data that can be obtained “conventionally” by a subscriber, with other units. This allows effective pairing between the VOD server and each user unit, so that the content for a given user unit can be exclusively used by this unit and by none other.

Mode with Content Personalized by a Specific Key

In the embodiment disclosed in FIG. 4, the content CT of the managing centre 10 is stored pre-encrypted. In this case, the content (CT) in clear is encrypted before with a set of control words cw. These encrypted content is represented in the figure by cw(CT). It is stored in the form resulting from this encryption. When it must be transmitted, the pre-encrypted content is first encrypted with the key Kₙ specific to the user unit 12 having requested the sending of the file. The content is represented in the drawings as having the form Kₙ (cw (CT)). It is then sent in this form to the concerned user unit. This presents the advantage that it is not necessary to store the content in clear in the managing centre, which is in practice little appreciated by owners of the media.

The control words cw are furthermore conventionally encrypted and are sent in the ECM stream to the receiver.

To decrypt the content received by the user unit, in the embodiment of FIG. 4, it is first necessary to conventionally decrypt the control words received in the ECM stream. Then, it is necessary to decrypt, the content Kₙ (cw (CT)) received from the managing centre 10 with the key Kₙ. The content is thus obtained such that it is memorized in the managing centre, that is to say the pre-encrypted content cw (CT). At this stage, it is possible to apply to those data, the control words cw in clear, coming from the ECM stream. One then obtains the content CT in clear.

Mode with Control Words Personalized as in FIG. 2 and Content Personalized as in FIG. 3

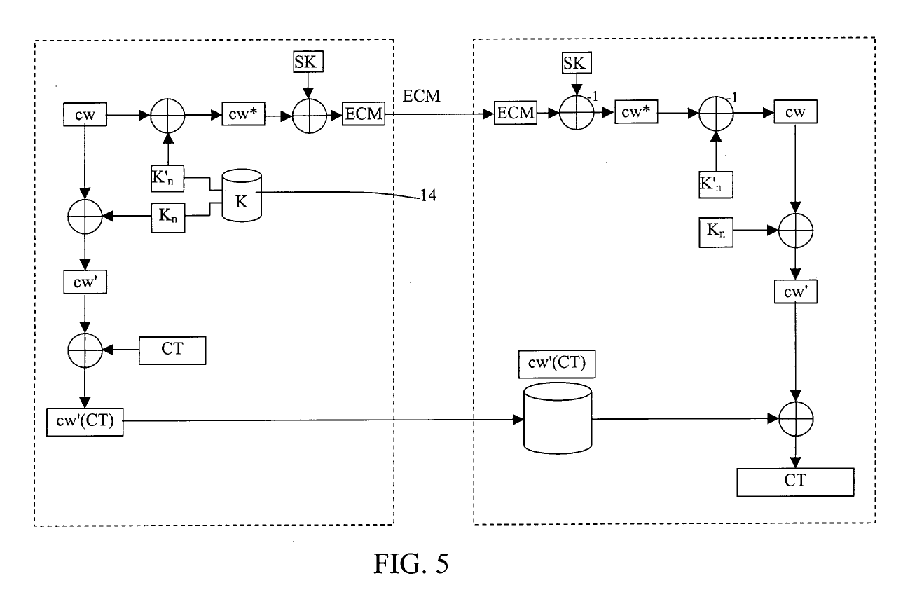

FIG. 5 shows an embodiment in which the control words cw are personalized in a similar way to that which has been described with reference to FIG. 2 and the content is personalized in a similar way to that which has been described with reference to FIG. 3. With regard to the control words, these are first encrypted with a first key K′ₙ specific to the user unit. This key can be symmetrical or asymmetrical. The encrypted control words cw*=K′ₙ (cw) are obtained. These are then conventionally encrypted with the system key SK to be transmitted, in the ECM stream, to the concerned user unit. By applying the symmetrical key or the other key of the key pair, when the key K′ₙ is asymmetrical, it is possible to decrypt the control words cw* and to obtain these words in clear.

At the same time, the control words cw are encrypted with a key Kₙ necessarily symmetrical, specific to the user unit, coming from the database 14 connected to the managing centre. The encrypted control words cw′=Kₙ (cw) are obtained in this way. These are then used to encrypt the content to be transmitted, as in the embodiment of FIG. 3. These content is then sent to the concerned user unit 11. Decryption of the content is done as has been explained with reference to FIG. 3. More precisely, the control-words cw* are decrypted by means of the key K′ₙ. They are then re-encrypted by means of the key Kₙ, which allows one to obtain the encrypted control words cw′. These are applied to the encrypted content cw′(CT) received from the managing centre, in such a way as to find the content CT in clear.

It should be noted that, in this embodiment, the principle of pre-encrypted storage shown with reference to FIG. 4 is applicable by analogy. Thus, it is possible, in all cases, to store a pre-encrypted content in the managing centre, while personalizing either the ECM stream, or the data stream, or both.

Mode with Personalized Control Words as in FIG. 2 and Personalized Content as in FIG. 4

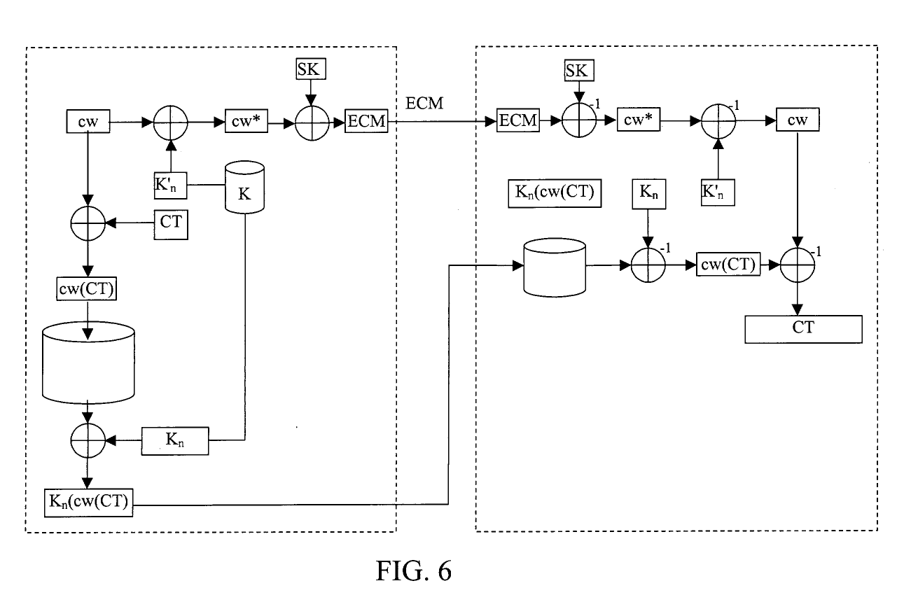

FIG. 6 is a variant of the method in which the control words cw and the data stream CT are also personalized. The control words are personalized in the same way as described with reference to FIG. 5. They are encrypted with a first key K′ₙ specific to the concerned user unit, and then conventionally encrypted again, with the system key SK in order to be transmitted, in the ECM stream, to the concerned user unit.

The content is personalized in the same way as the embodiment in FIG. 4. The content (CT) in clear is first encrypted with the control words cw. Before being transmitted, the pre-encrypted content is first encrypted with the key Kₙ specific to the user unit having requested the sending of the content. It is then sent to the concerned user unit.

To decrypt the content received by the user unit, it is first necessary to decrypt, the control words received in the ECM stream with the system key SK and with the personalized key K′ₙ.

Then, it is necessary to decrypt the content received from the managing centre with the key Kₙ. The content is thus obtained as it was memorized in the managing centre, that is to say the pre-encrypted content cw (CT). At this stage, it is possible to apply the control words cw in clear, coming from the ECM stream to those data. The content CT is then obtained in clear.

Both above described embodiments present increased security compared to the previous embodiments and to those of the prior art, as both streams, which are transmitted between the managing centre 10 and the concerned user unit 11 are specific to this unit. This means that even if a non-authorized person is capable of decrypting one of the streams, he cannot use it without decrypting the other stream.

In these embodiments, the keys K′ₙ and Kₙ can be different. If these two keys are symmetrical, it is also possible to use a single, same key for both encrypting operations. It is also possible to foresee that one of the keys is in the receiver/decoder while the other key is in the associated security module. This is particularly interesting because of the fact that it allows one to ensure that the decoder and the security module used are paired and provided to communicate to each other.

Multi-User Units Diffusion Mode

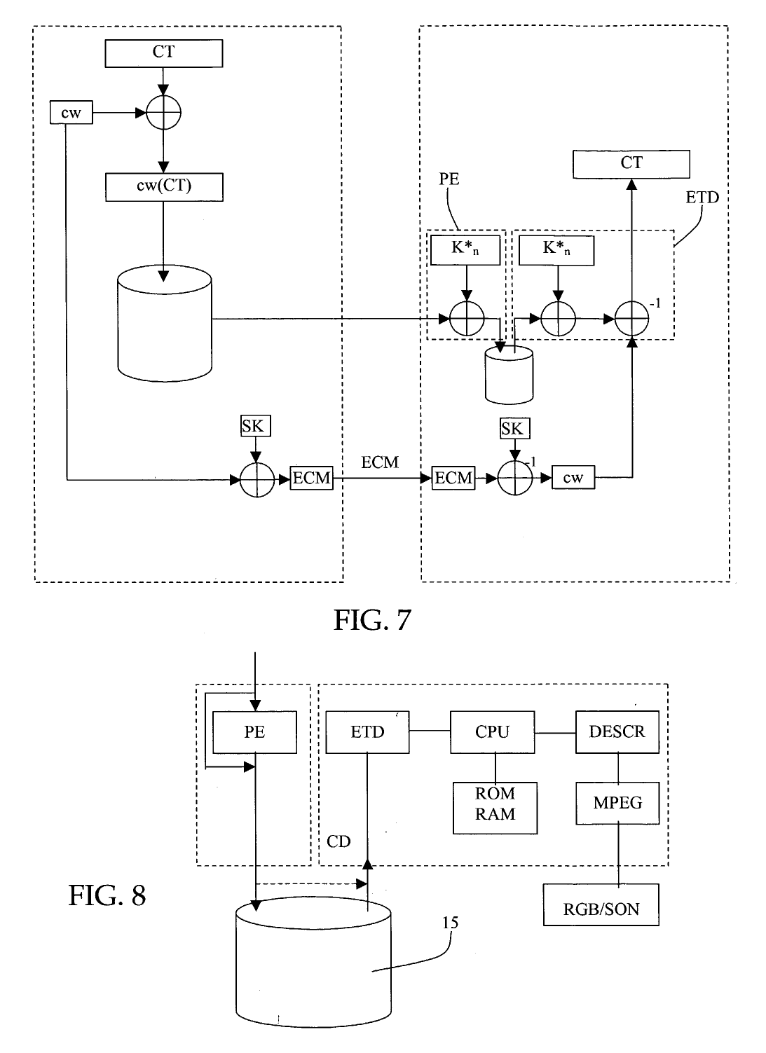

The above description explains different ways of carrying out a process of data transmission in a point-to-point way. It can be desirable that a user unit for implementing this method can also be used for diffusion, in which case, the content CT and the control words cw are commonly encrypted, for all the users. FIG. 7 describes an embodiment in which the content CT and the control words cw are commonly encrypted, for all the users. This means that the data and the control words are common to all the receivers, which allows one to apply this embodiment to broadcasting.

Conventionally, the data CT are encrypted with the control words cw. The control words cw are for their part encrypted with the system key SK. The content and the ECM stream are transmitted to the receiver. When the content is received in the receiver, it is encrypted by means of a key K*ₙ which is advantageously symmetrical, although an asymmetrical key could also be used. This key K*ₙ is specific to the user unit. The stream can be stored in the mass storage 15. When the content of this memory must be used, first it is decrypted with the key K*ₙ, then it is decrypted a second time, with the control words cw, in such a way as to obtain the content in clear. The key K*ₙ is advantageously memorized in an electronic module such as a microprocessor of the receiver. It is recalled that, while the control words change generally at regular intervals, the key K*ₙ clearly has a longer life time and can for example be registered definitively and unchanged in the user unit. This embodiment offers different advantages compared with a conventional data security transmission. As the content is encrypted in the user unit before the memorization with a key K*ₙ specific to this one, a third party who would divert this content could not use it on another user unit for which the content is intended. Furthermore, even by decrypting the content when introduced in the receiver, use of this content in another receiver would be useless. In fact, each receiver expects to receive a content encrypted with the key K*ₙ which is its own. If one introduces content in clear into a receiver expecting to receive an encrypted content, this receiver will proceed to decrypt the data in clear and will thus return them unusable.

Another advantage of this execution is the fact that copying a file such as a video file is possible on a receiver/decoder, but that this copy cannot be used on another receiver/decoder. In fact, the copy delivers the content encrypted by the control words cw and by the personal key K*ₙ. As this personal key is different for each receiver/decoder, decrypting the copy is not possible. This offers thus effective protection against the illicit copy.

In the embodiment disclosed in FIGS. 4 and 7, it is necessary to decrypt the content twice. In the case of FIG. 4, a first decryption is the opposite operation to encryption with the control words cw′ specific to one of the user units and the second decryption is the opposite operation to encryption with the control words cw common to all the user units. This kind of decryption is not possible with the electronic microprocessors existing at present.

FIG. 8 schematically shows a electronic module constructed to carry out such decryption. With reference to this figure, the module (CD) of the invention essentially includes a calculation unit (CPU), memory (ROM, RAM), a descrambler (DESCR), a sound and images decompressor (MPEG) and a decrypting stage (ETD). The decrypting stage (ETD) decrypts the content which have been over-encrypted with the specific key K*ₙ of the embodiment in FIG. 7, on entering the receiver/decoder.

When the user unit is used in broadcasting mode, this over-encryption is obviously not carried out, because the data are common to all the receivers/decoders. This is why, an encrypting stage (PE) is activated, in which an encryption is applied to the content with the same specific key K*ₙ. It is only after this stage that the content can be stored in a mass storage unit 15 that can optionally contain such a user unit.

This encryption stage (PE) advantageously consists of a single circuit in which the specific key K*ₙ is difficult to obtain. This circuit is paired to the electronic module (CD) because the same key is in these two elements.

If one wishes to dispose of a user unit, which is compatible with the point-to-point mode and the broadcasting mode, the encryption stage (PE) must be commutable. In fact, if the content is encrypted by the specific key K*ₙ on the transmitting side, this stage must be able to be disconnected. This does not pose a problem in terms of security because the decryption stage (ETD) in the electronic module (CD) cannot be disconnected. So, if one deactivates the encryption stage (PE) in a broadcasting mode, the content so applied to the electronic module (CD) cannot be correctly decrypted because the decrypting stage (ETD) decrypts the content with the specific key K*ₙ, content which will not have been encrypted with this key.

The decryption stage (ETD), identical to the encryption stage (PE), can carry out a relatively quick and simple operation. It is for example possible to use a function XOR, which does practically not generate any delay in transmission of the content. For data in a series, it is known to use encryption stages series that are initialised according to a specific sequence.

It should be noted that the decryption stage (PE) could also be integrated in the electronic module as this module disposes of an exit from the encryption stage to send the content in the mass storage 15, and of an entry in the decryption stage to decrypt the content coming from this storage.

Pairing

Generally, when a user unit has a receiver/decoder and a security module, each of these two elements includes a key, known as the pairing key Kₚ, which is different for each user unit, and which can be symmetrical or asymmetrical. The ECM stream is received by the security module to be decrypted and to extract the control words thanks to the system key SK. The transmission of the control words of the security module towards the receiver/decoder is done in the encrypted form, either with the pairing key Kₚ, or with a session key depending on this pairing key. This is described in detail in publication WO 99/57901. The control words are decrypted in the decoder thanks to the key relating to the one used for encrypting. This allows one to insure that only one security module operates with a single receiver/decoder and that these elements are thus paired.

In this invention, it is also possible to guarantee the pairing in different ways, either between the security module and the receiver/decoder, or between the managing centre and the receiver/decoder.

Pairing Between the Security Module and the Receiver/Decoder

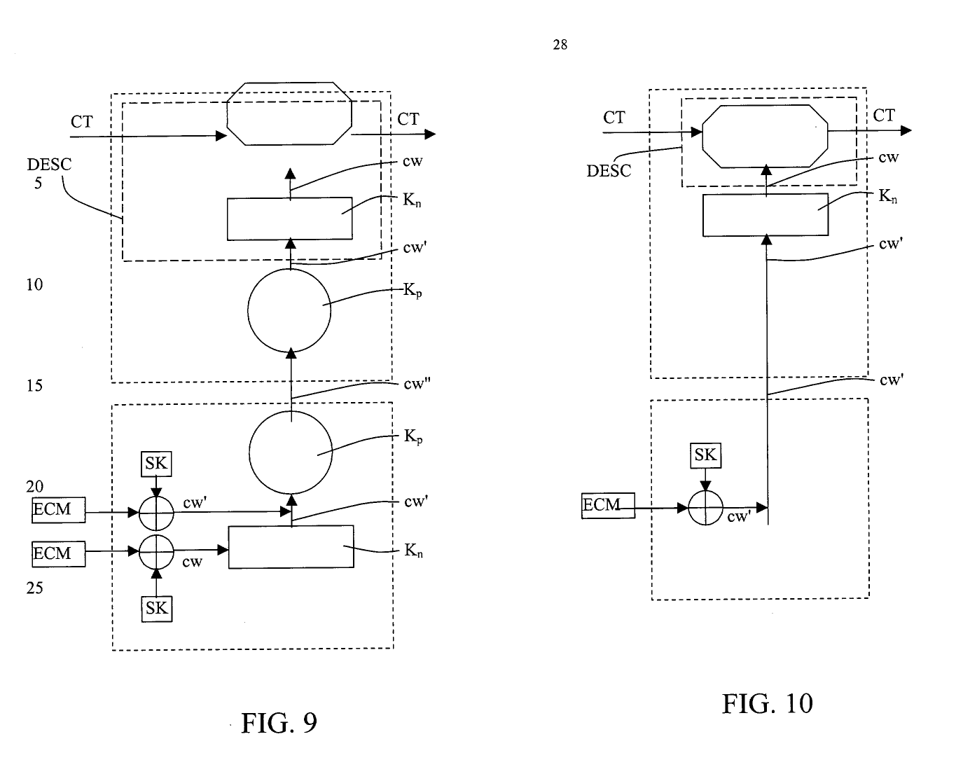

FIG. 9 shows an embodiment in which the receiver/decoder is paired with the security module. In the represented case, the user unit has two keys, namely the key Kₙ specific to each user unit on the one hand, and on the other hand, the pairing key Kₚ. For compatibility reasons between the point-to-point mode and the broadcasting mode, the specific key Kₙ is also memorized in the security module.

Broadcast Mode

When the user unit is used in the broadcast mode, the ECM stream containing the control words cw is introduced into the security module. One then extracts the control words cw by means of the system key SK. The control words are then re-encrypted with the specific key Kₙ to obtain the encrypted words cw′. These are then encrypted, again in the security module, by means of the pairing key K_{P} to obtain cw″=Kₚ (cw′). They are transmitted to the receiver/decoder in this form. In the latter, the encrypted control words cw″ are first decrypted with the pairing key Kₚ. They are then decrypted again with the specific key Kₙ to obtain these control words cw in clear. They can then be used to decrypt the content CT.

In the embodiment disclosed in FIG. 9, the specific key is memorized in the descrambler. This key can be inscribed there definitively (PROM, ROM). The pairing key can be a software key memorized in the decoder, outside the descrambler. Both keys could also be registered in the descrambler or outside it.

Point-to-Point Mode

When the user unit is used in the point-to-point mode, the ECM stream containing the control words cw′ has been personalized in the managing centre. Thus it is not necessary to carry out an encryption with the specific key Kₙ. The ECM stream is thus decrypted by means of the system key, to remove the control words. These are then directly re-encrypted with the pairing key Kₚ before being sent to the receiver/decoder. Here, they are first decrypted by means of the pairing key Kₚ, then by means of the specific key Kₙ. This allows one to obtain the control words cw in clear.

Pairing Between the Managing Centre and the Receiver/Decoder

The embodiment of FIG. 10 represents an example in which the pairing is carried out between the managing centre and the receiver/decoder. The control words are encrypted by means of the specific key Kₙ, as has been described with reference to FIG. 2 especially. The ECM stream containing these specific encrypted control words cw′ is sent either to the security module which transmits it without change to the receiver/decoder, or directly to the receiver/decoder without passing through the security module. There they are then decrypted by means of the specific key Kₙ to obtain them in clear. This embodiment allows one to carry out pairing between the managing centre and the receiver/decoder, since only the receiver/decoder having the specific key, which is memorized in the managing centre, will give a usable result.

As previously mentioned, the keys can be immutable and be registered definitely in a microprocessor of the receiver. They can also be registered in the security module of each user unit. These keys can also be sent from the managing centre and so be modified. One way of doing this is for example to send a new key in a highly secured stream of control messages, called “master ECM”. This allows improving the security because it is possible to change the key after a certain duration of use.

1. Process for point-to-point secured transmission of data between a managing centre (10) and a unit among a plurality of user units linked to said managing centre, said data including a content (CT) encrypted by at least one control word (cw), each user unit including at least one decoder/receiver (12) provided with at least one encryption key (K₁, K₂, . . . Kₙ) specific to each user unit,
characterized in that it includes the following steps
transmitting a request from the user unit (D₁, D₂, . . . Dₙ) to the managing centre requesting the sending of a specific content (CT),
transmitting a unique identifier (UA₁, UA₂, . . . UAₙ) to the managing centre, this identifier allowing to unequivocally determine the user unit having transmitted the request,
determining, from a database (14) associated with the managing centre, the key (Kₙ) corresponding to said user unit having transmitted the request,
determining the control word or words associated with the content (CT) to be transmitted,
encrypting these control words (cw) with said key (Kₙ) corresponding to said user unit having transmitted the request, to obtain encrypted control words (cw′, cw*),
transmitting the encrypted control words (cw′, cw*) to the user unit having transmitted the request, and
transmitting said encrypted content to the user unit having transmitted the request.

2. Process for secured transmission of data according to claim 1, characterized in that the content (CT) to be transmitted is encrypted exclusively by the initial control words (cw).

3. Process for secured transmission of data according to claim 1, characterized in that the content (CT) to be transmitted is encrypted by the control words (cw′) encrypted with said key (Kₙ) specific to each user unit.

4. Process for secured transmission of data according to claim 1, characterized in that the content (CT) to be transmitted is encrypted by the initial control words (cw) and with said key (Kₙ) specific to each user unit.

5. Process for point-to-point secured transmission of data between a managing centre (10) and a unit among a plurality of user units linked to said managing centre, said data including a content (CT) encrypted by at least one control word (cw), each user unit including at least one decoder/receiver (12) provided with at least one encryption key (K₁, K₂, . . . Kₙ) specific to each user unit,
characterized in that it includes the steps consisting of:
transmitting a request from the user unit (D₁, D₂, . . . Dₙ) to the managing centre requesting the sending of a specific content (CT),
transmitting a unique identifier (UA₁, UA₂, . . . UAₙ) to the managing centre, this identifier allowing to unequivocally determine, the user unit having transmitted the request,
determining, from a database (14) associated with the managing centre, the key (Kₙ) corresponding to said user unit having transmitted the request,
determining the control word or words (cw) associated with the content (CT) to be transmitted,
encrypting the data (CT) to be transmitted, in a specific way for each user unit,
transmitting these encrypted content to said user unit having transmitted the request,
transmitting the encrypted control words (cw*) to the user unit having transmitted the request.

6. Process for secured transmission of data according to claim 5, characterized in that the content to be transmitted is encrypted by the key (Kₙ) specific to the receiver.

7. Process for secured transmission of data according to claim 5, characterized in that the control words (cw) are encrypted with said key (Kₙ) corresponding to said user unit having transmitted the request, in order to obtain encrypted control words (cw′), and in that the content to be transmitted is encrypted by these encrypted control words (cw′).

8. Electronic module including a calculation unit (CPU), memory (ROM, RAM), a descrambler (DESCR), a sound and images decompressor (MPEG) and a decryption stage (ETD) working with a key specific to each user unit.
